(19) United States
(12) Patent Application Publication
(10) Pub. No.: US 2011/0132783 A1
(43) Pub. Date: Jun. 9, 2011

(54) DURABLE PACKAGING ASSEMBLY FOR ARTICLES

(76) Inventors: David L. Williams, Prescott, WI (US); John Tomczyk, Shoreview, MN (US)

(21) Appl. No.: 12/962,344

(22) Filed: Dec. 7, 2010

Related U.S. Application Data
(60) Provisional application No. 61/267,340, filed on Dec. 7, 2009.
(60) Provisional application No. 61/306,859, filed on Feb. 22, 2010.

(51) Int. Cl. B65D 85/00; G06K 19/06; B65B 5/04; G06K 19/00; B65D 67/00; B65B 17/00

(52) U.S. Cl. 206/307; 235/493; 235/494; 235/487; 206/457; 53/410

(57) ABSTRACT

A carrier assembly for transaction cards or other articles. The assembly includes a carrier having a front panel and a rear panel, and a transaction card or other article retained within the carrier. At least one panel of the carrier comprises a lens sheet assembly including a lens sheet, and an optional image layer. The carrier with lens sheet assembly provides enhanced security features, increased durability, and eye-catching features compared to traditional carrier or packaging assemblies.

### RELATED APPLICATION

The present application claims priority to U.S. Provisional Application No. 61/267,340 entitled “DIMENSIONALLY IMAGED CARRIER ASSEMBLY FOR TRANSACTION CARDS,” filed Dec. 7, 2009, and to U.S. Provisional Application No. 61/306,859 entitled “DIMENSIONALLY IMAGED CARRIER ASSEMBLY FOR MEDIA DEVICES,” filed Feb. 22, 2010, both of which are incorporated herein by reference in their entireties.

### FIELD OF THE INVENTION

The invention relates generally to packaging for a variety of articles such as stored-value cards and media devices. More particularly, the invention relates to an attractive yet tamper-evident carrier assembly including a plurality of panel portions, and a transaction card and/or other articles enclosed within the panel portions.

### BACKGROUND OF THE INVENTION

Packaging of articles can offer a variety of features including eye-catching features to enhance attractiveness of the packaging and to attract potential buyers, as well as offer security features so that the article(s) contained within the packaging cannot be easily removed or to reduce or prevent and/or detect the perpetration of fraud. Such packaging is desired for articles including cards that are associated with a metered account, such as a transaction card. Transaction cards can include, for example, credit or debit card, prepaid cards, loyalty cards, gift cards, and any of a variety of cards with one or more forms of human- and/or machine-readable markings or indicia thereon associated with a metered account. The indicia can allow a customer or user to access account information, activate the account, and/or conduct transactions against the account.

The transaction card industry includes a number of structures for packaged transaction card assemblies. In one type of packaging assembly, the transaction card and the package, respectively, are separately manufactured from different substrates, and thereafter detachably interconnected in such a way that various indicia, such as, for example, personal identification numbers (“PINs”), account numbers, or other alphanumeric indicia, on the card is concealed by the package. Activation indicia is positioned on the card in various formats, including, without limitation, in or on magnetic stripes, bar codes, RFID, or various forms of alphanumeric codes. The activation indicia is typically exposed and the prepaid account can be activated at the cash register when the packaged card assembly is purchased. See, for example, U.S. Pat. No. 5,760,381 entitled “Prepaid Card” to Stitch et al., and U.S. Pat. No. 5,918,909 entitled “Package for Card with Data-Encoded Strip and Method of Using Same” to Fiala et al., both of which are hereby incorporated by reference in their entireties.

One problem with this type of packaged assembly is the combination of the various types of indicia identified above and the activation indicia are on the same card, and the card is exposed and not otherwise concealed within the package, in whole or in part. In fact, many of the cards of this type of package assembly are removably adhered to the package with “rubber cement-type glue,” otherwise known as fugitive glue. Because the cards are exposed and not otherwise concealed within the package, they can be easily stolen from a store by removing the cards from their larger packages, and can then be resold either after illegal activation of the prepaid accounts or after deceiving buyers into believing that the accounts have been activated.

Another type of prior packaged card assembly is one wherein the card and the package have been manufactured jointly from the same substrate, with a perforated or die cut line providing easy detachment of the card from the package. In such case the various indicia, such as, for example, the PIN, account number, or other indicia or alphanumeric codes that identify the account, is on the card in a location typically concealed by a scratch off label of various sorts, such as a printed layer of scratch-off material or a label, while the account activation indicia, such as that contained within the barcode, magnetic stripe, or RFID, is on the package in an exposed location for activation of the prepaid account at the cash register. As with the two-piece hang card assembly mentioned above, this type of assembly allows for easy removal of the card from the package, but more importantly, exposes the card completely and therefore limits the uses of the package assembly. In particular, the various indicia, including any magnetic stripes, barcodes, etc. can be readily tampered with if not concealed by the packaging. This limits the uses of the card product to closed loop card product applications, i.e. retail store cards and the like, as they are not secure enough for open loop card product uses, i.e. cards that can be used at various locations and retailers, such as VISA, Mastercard, Discover, and American Express card products.

Solutions to this latter problem have been attempted, as exemplified by U.S. Pat. No. 5,650,209 entitled “Manufacture of Telephone Debit Cards” to Ramsburg et al., which is hereby incorporated by reference, wherein the card portion of the common substrate of a card/package combination is laminated in plastic to improve its durability. However the resultant durability and added security does not approach the durability and security that is obtainable by manufacturing the card separately from the package and having the package enclose the card, in whole or in part. Another approach to this problem is exemplified in U.S. Pat. No. 6,543,809 entitled “Simplified Data Package Assembly” to Kistner et al., incorporated herein by reference in its entirety.

Yet another type of packaged card assembly which addresses the above-problem is one which includes a data card assembly or transaction card assembly with personal identifying indicia and one or more forms of account verification indicia. The account verification indicia includes distinctive or identifying marks or indications that are correlated to an account for verifying association of a card or a package with the account. The card is removably attached to a panel so that personal identifying indicia on the card, inner surface of a panel, or on a separate substrate or label contained within the package are concealed by the panel. First account verification indicia is positioned on the card and is visibly exposed by the panel. Second account verification indicia, either identical to or different from the first account verification indicia, is positioned on the package in an exposed location. The first and second account verification indicia are both correlated with the same account, thereby enabling confirmation that the personal identifying indicia on the card and the activation indicia on the package are both correlated with the same prepaid or metered account.

Examples of assemblies can be found in U.S. Pat. No. 6,224,108 entitled “Packaged Data Card Assembly,” U.S. Pat. No. 6,328,341 entitled “Multiple-Component Data Package,” U.S. Pat. No. 6,439,613 entitled “Multiple-Component Data Package,” and U.S. Pat. No. 6,715,795 entitled “Multiple-Component Data Package,” all to Klure (hereinafter referred to as “the Klure Patents”), and all of which are incorporated herein by reference in their entireties.

Existing packaging assemblies have limited real estate for displaying eye-catching features, and customers have become accustomed to the currently offered two-dimensional features providing limited or no additional incentive to buy the particular assembly. There remains a need for a packaged transaction card assembly that further increases security features and/or includes one or more new eye-catching features to entice customers and boost sales of the assembly.

### SUMMARY OF THE INVENTION

Packaging assemblies for articles according to embodiments of the invention overcome many of the issues associated with the carriers described above. A carrier of the present invention can be economically and efficiently produced, while providing enhanced security features, enhanced structural integrity, as well as offering eye-catching features.

In one embodiment of the invention, a carrier assembly for transaction cards generally includes a paperboard or polyboard carrier having front and rear panels, and a transaction card removably contained to the carrier and sandwiched between the front and rear panels. At least a portion of one of the panels that make up the package assembly includes a polymeric flexible lens sheet assembly, such as a lenticular or fly's eye sheet, with one or more images viewable therethrough. The front panel can comprise the lens sheet, the lens sheet can be applied or adhered to an exterior of the front panel, or a lens sheet can be applied to an interior of the front panel through a window in the front panel.

The lens sheet of the embodiments includes a plastic or polymeric lens sheet having a plurality of lenticular lenses, fly's eye lenses, or any of a variety of lenses on a first surface of the lens sheet, and one or more corresponding images on a second, flat surface of the lens sheet, viewable through the lens sheet. The image can be printed directly on the flat surface of the lens sheet, and/or on a separate substrate laminated to the flat surface of the lens sheet. The image can comprise an interlaced image, hologravure image, and/or combinations thereof.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a front perspective view of a two-panel assembly according to an embodiment of the invention;

FIG. 2 is a rear perspective view of the assembly of FIG. 1;

FIG. 3 is a cross-sectional view of a two-panel assembly according to one embodiment of the invention;

FIG. 4 is a cross-sectional view of a two-panel assembly according to another embodiment of the invention;

FIG. 5 is a cross-sectional view of a multi-card assembly according to another embodiment of the invention;

FIG. 6 is a partially exploded cross-sectional view of a two-panel assembly according to yet another embodiment of the invention;

FIG. 7 is a front perspective view of a two-panel assembly according to another embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

A carrier assembly according to embodiments of the invention includes a plurality of panels foldably or otherwise coupled to one another to enclose or sandwich an article, such as a transaction card, a media device, or both within the carrier. The carrier comprises one or more panels comprising polymeric materials such that the resulting carrier assembly is flexible and durable, and cannot be easily torn or otherwise breached. The polymer-containing carrier can comprise, for example, polyboard, paperbord with one or more polymer coatings, laminates, or layers over at least a portion thereof, or paperboard containing a polymer material dispersed therethrough.

In one embodiment of the invention, a paperboard material with one or more polymer layers includes an extrusion coated paperboard for heat sealing applications, such as, for example, Printkote EasySeal® Plus paperboard, available from MeadWestvaco, the product specification of which is incorporated herein by reference in its entirety, and is available at: http://www.meadwestvaco.com/mwv/groups/content/documents/document/mwv013505.pdf.

At least one panel comprises an eye-catching display panel to attract potential purchasers of the carrier assembly, and/or to provide enhanced security features. In one embodiment of the invention, the eye-catching display panel comprises a lens sheet assembly formed of a polymeric lens sheet such as a lenticular lens or fly's eye lens sheet, and one or more images viewable therethrough. In an alternative embodiment of the invention, the eye-catching display panel comprises printed specialty graphics including foil features, textured printing, embossing, lithographic printing, or combinations thereof.

The lens sheet assembly can provide multiple images, 3D or depth effect, and/or animation/motion to the carrier, thereby offering additional advantages to traditional secure or non-secure transaction card carriers. For example, the lens sheet assembly offers eye-catching or enhanced attractiveness to the packaging because the features displayed by the lens sheet assembly draws notice to the article, and the recipient will often look at the article for an amount of time sufficient to receive at least a part of the intended message. Additionally or alternatively, the carrier with lens sheet assembly can provide enhanced security features to traditional carriers because the image viewable through the lens further obscures the view of a card within the carrier. Further, because the lens sheet comprises a polymeric material that is difficult to tear without damage, the durability of the carrier increases from traditional paper stock or card stock so as to form tamper-proof or tamper evident package.

The carriers according to embodiments of the invention can be used to package any of a variety of articles, such as, for example, cards or other articles that are associated with a metered account, such as a transaction card. Transaction cards can include, for example, credit or debit card, prepaid cards, loyalty cards, gift cards, and any of a variety card with one or more forms of human- and/or machine-readable indicia thereon associated with a customer-user metered account. Other articles can include identification cards, media devices such as DVDs, CDs, BluRay discs, laser discs, and/or the like.

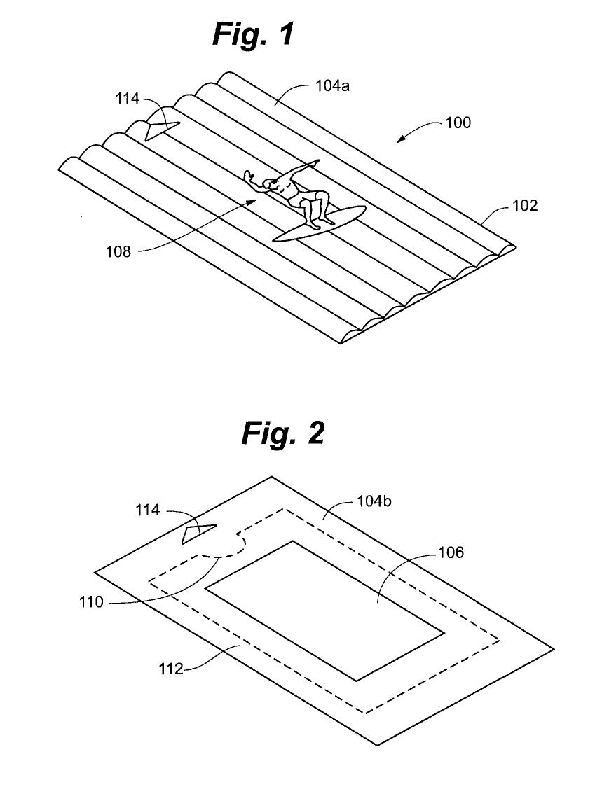

Referring to FIGS. 1 and 2, a carrier assembly 100 generally includes a carrier 102 having a front panel 104a, a rear panel 104b, and one or more transaction cards 106 removably contained within and sandwiched between panels 104.

One or more of panels 104 comprises a lens sheet assembly 108 including a lens sheet and one or more corresponding images viewable therethrough. Carrier 102 can also optionally include a tab 110 for ease of opening, tab 110 being defined in rear panel 104b by a line of weakening, such as a perforated edge 112. Perforated edge 112 can be formed by any of a variety of scoring techniques such as, for example, laser scoring, knife scoring, die scoring, and combinations thereof.

In one representative embodiment, carrier 102 with tab 110 is of sufficient rigidity or stiffness that when carrier 102 is flexed, at least a portion of perforated edge 112 is automatically ruptured, without the need to insert a finger under tab 110, for exposing at least a portion of card 106 or for removal of card 106 from between panels 104.

Carrier 102 can also comprise hanging apertures 114 on either front panel 104a or rear panel 104b, or both for displaying carrier assembly 100 on a rack, such as in a retail environment.

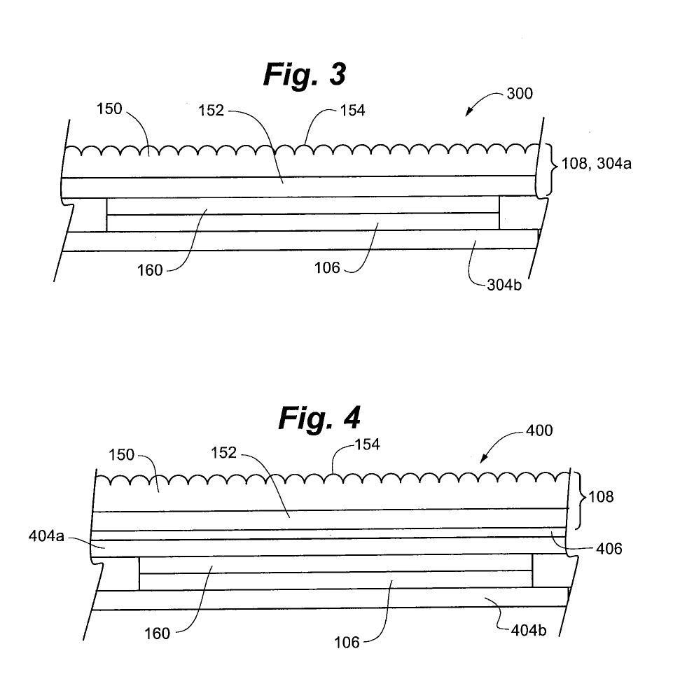

Referring to FIGS. 3 and 4, at least a portion of an exterior of one panel of assembly 300/400 comprises a lens sheet assembly 108. The panels are then coupled or bonded together to sandwich card 106 between.

In one embodiment of the invention, referring specifically to FIG. 3, assembly 300 comprises a front panel 304a and a rear panel 304b. In this embodiment, front panel 304a comprises lens sheet assembly 108, such as, for example, a lenticular or fly's eye imaged sheet. Rear panel 304b comprises a substrate, such as paperboard, cardboard, polymer backing, or polyboard, without a lens sheet assembly. Front panel 304a is coupled to rear panel 304b by any of a variety of fastening mechanisms, such as, for example, an adhesive, heat sealing, or welding, to sandwich card 106 between panels 304. In one embodiment, an adhesive is applied to a perimeter of each panel 304.

As stated above, one or more transaction cards 106 are removably attached to one or both panels 304. Card 106 can be removably connected by well-known means such as the use of appropriate adhesives, slits, pockets, enclosures, rivets, stickers, or the like, and/or combinations thereof, either with or without tamper-revealing structures. In one embodiment of the invention, card 106 is removably contained to rear panel 304b by a removable adhesive, or fugitive adhesive, such as rubber cement, that allows the attachment and detachment of card 106 to rear panel 304b without damage to either card 106 or rear panel 304b. Alternatively, card 106 is held to a panel of the package assembly by another one of the panels that comprise the package assembly (tight fit or friction fit assembly) without the aid of glue or other fastening mechanisms.

In an alternative embodiment of the invention not shown, card 106 is integral with one or more panels 304 and is removably coupled by one or more perforations on one or more common edges, similar to the construction found in U.S. Pat. No. 6,543,809, incorporated by reference above.

Optionally, assembly 300 includes a set of terms and conditions 160 or other information, advertising, offers, coupons, and/or the like, that correlate to or correspond with card 106 and the prepaid account. Terms and conditions set 160 can be coupled to front panel 304a and/or rear panel 304b such that it is sandwiched between panels 304 with card 106. Alternatively, terms and conditions set 160 are snug or friction fit between two or more panels of the package assembly and require no additional affixing mechanism. Terms and conditions set 160 can comprise, for example, one or more pieces of paper (folded or unfolded) that is adhered to the inside of front panel 304a.

In another embodiment of the invention, referring specifically to FIG. 4, assembly 400 comprises a front panel 404a and a rear panel 404b. Front panel 404a includes a lens sheet assembly 108 secured thereto. For example, front panel 404a comprises a substrate such as paperboard, cardboard, polymer backing, or polyboard, as described above. Lens sheet assembly 108 is secured by any of a variety of means to an outer surface of front panel 404a. Lens sheet assembly 108 can be secured to front panel 404a by adhesive 406, for example. Rear panel 404b comprises a substrate, such as paperboard, cardboard, polymer backing, or polyboard, without a lens sheet assembly. Rear panel 404b can comprise the same or different substrate as front panel 204a. For example, both front and rear panels 404a, 404b can comprise polyboard. Alternatively, front panel 404a can comprise paperboard, while rear panel 404b comprises polyboard, or vice versa. Front panel 404a is coupled to rear panel 404b by any of a variety of fastening mechanisms, such as, for example, an adhesive, heat sealing, or welding, to sandwich card 106 between panels 404.

As stated above, one or more transaction cards 106 are removably contained between one or both panels 404 of assembly 400. Card 106 can be removably contained by well-known means such as the use of appropriate adhesives, slits, pockets, enclosures, rivets, stickers, or the like and/or combinations thereof, either with or without tamper-revealing structures. In one embodiment of the invention, card 106 is removably contained to rear panel 404b of assembly 400 by a removable adhesive, or fugitive adhesive, such as rubber cement, that allows the attachment and detachment of card 106 to rear panel 404b without damage to either card 106 or rear panel 404b.

In an alternative embodiment of the invention not shown, card 106 is integral with one or more panels 404 and is removably coupled by one or more perforations on one or more common edges, similar to the construction found in U.S. Pat. No. 6,543,809, incorporated by reference above.

Optionally, assembly 400 includes a set of terms and conditions 160 that correlate to or correspond with card 106 and the prepaid account. Terms and conditions set 160 or other information described above can be coupled to front panel 404a and/or rear panel 404b such that it is sandwiched between panels 404 with card 106. Terms and conditions set 160 can comprise, for example, one or more pieces of paper (folded or unfolded) that is adhered to the inside of front panel 404a.

In the embodiments of FIGS. 3 and 4, one or both panels can include one or more apertures for viewing a portion of card 106 as desired. For example, a control number, bar code, or other type of alphanumeric code or indicia printed or otherwise positioned on the card is viewable through the aperture in order to ensure that the card corresponds to the correct packaging. In some embodiments, one or both panels also have apertures, such as a sombrero hanging aperture, which align when the panels are coupled together to enable the package to be hung for retail display.

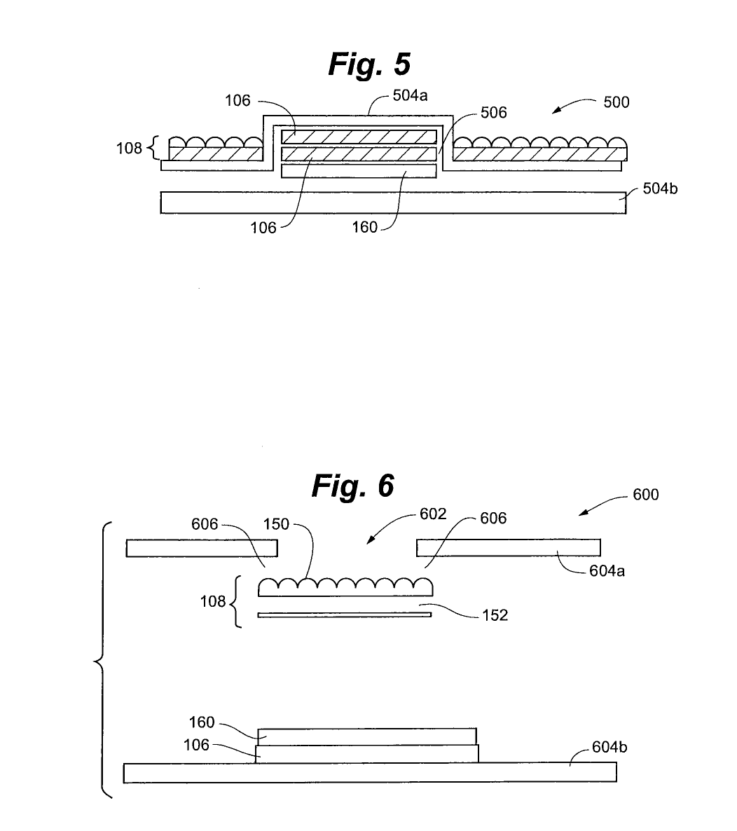

In an alternative embodiment shown in FIG. 5, an assembly 500 comprises a multipack including a plurality of cards 106. A vacuum formed front panel 504a can be formed around cards 106 and coupled to a rear panel 504b. A lens sheet assembly 108 can be applied to one or more areas of front panel 504a and/or to rear panel 504b. Alternatively, lens sheet assembly 108 comprises a single sheet with a window 506 defined thereon such that cards 106 protrude through window 506.

In this multipack configuration, cards 106 can all be correlated with a single account, or can be correlated with multiple accounts. In the former case, cards 106 each have identical account verification indicia to each other, and the accounts associated with each card can be activated by a single activation indicia. In the latter case, cards 106 can each have unique account verification indicia, and can be activated independently to each other by one or more activation indicia on each card or carrier. Alternatively, a single activation indicia can activate each of the accounts simultaneously, regardless of whether the account verification indicia. In each of the multipack configurations described herein, variations in the various indicia, including account verification indicia, can be the same, identical, or different from card to card within a package.

In the embodiments, and again referring back to FIGS. 3 and 4, lens sheet assembly 108 generally includes a lens sheet 150 having a plurality of lenses 154, and one or more image layers 152 viewable therethrough, as now described in more detail.

Lens sheet assembly 108 referenced in the embodiments generally includes a lens sheet 150 having plurality of lenses 154, and one or more image layers 152 viewable therethrough. Specifically, the lens sheet generally comprises a plastic lens sheet, such as, for example, APET, Polyethylene terephthalate glycol (PETG), polystyrene, polyvinylchloride (PVC), polyethylene, polypropylene, polylactic acid (PLA), recycled polymers such as recycled polyethylene, polystyrene, and polypropylene, blends of recycled polymers with virgin polymers, and combinations thereof. The lens sheet can have a thickness from about five to about ten mil in one example, from about ten to about twenty mil in another example, and from about twenty to about forty mil in yet another example.

The lens sheet includes a first surface having a plurality of lenses, such as lenticular or fly's eye lenses, and a generally planar second surface. The first surface of the lens sheet can be entirely covered by lenses or partially covered in one or more areas, such as described in Provisional Application Ser. No. 61/420,571, incorporated herein by reference in its entirety. In one embodiment of the invention, the first surface can comprise a graphic image layer on one or more portions of the first surface which do not contain lenses. In one embodiment, the lens sheet comprises a lenticular lens sheet having a pitch of from about 40 lenticules per inch (LPI) to about 200 LPI. The lens sheet assemblies can be of a thicker construction (e.g. ten mils or greater), such as those described in U.S. Pat. No. 6,900,944 entitled “Lenticular Card and Processes for Making”, or of a thinner constructions (e.g. ten mils or less), such as those described in U.S. Application Publication No. 2010/0134895 entitled “Thin Film High Definition Dimensional Image Display Device and Methods of Making Same,” both of which are incorporated herein by reference in their entireties.

One or more image layers are applied to at least a portion of the second, generally planar surface of the lens sheet. The image layer(s) can be printed directly on the second, generally planar surface of the lens sheet. Alternatively, the image layer(s) can be printed on the panel on which the lens sheet is to be applied, and an unprinted lens sheet can be secured thereto with a clear adhesive.

The image layer(s) can comprise a lineform image or interlaced image, hologravure image, or any of a variety of imaging techniques used to form a dimensional image. The image layer(s) can be applied by any of a number of printing techniques, such as, for example, lithographic, flexographic, screen printing, gravure, digital ink jet, digital drop on demand, digital thermal printing, digital laser printing, digital xerographic printing, and combinations thereof. The medium used for the image layer(s) can comprise, for example, acrylic inks, water-based inks, latex inks, toners, and/or the like that can be cured by air, radiation, heat, fuser roller, or combinations thereof.

The image layer(s) can comprise a standard, unidirectional interlaced image, a one-color animation technique, hologravure technique, bi-directional interlacing, or combinations thereof. In one embodiment, one-color animation is used. A one-color animation technique includes designing a dimensional image to get a desired dimensional effect by building the animation images from only one color which overprints other colors of a color process, such as a 4-CP separation. The advantage of one-color animation is that it is not necessary to have the colors in precise ink-to-ink registration. The animation will always be viewable and give high-quality dimension effect regardless of the register of the other colors. Because of the elimination or reduction of the need for critical ink-to-ink registration accuracy, web press printing with registration tolerances less than sheet fed press tolerances becomes a viable manufacturing option without compromising image quality.

In one embodiment of the invention, the image layer(s) comprise a hologravure image. Hologravure images, known by the trade name Infinidepth®, are similar to one-color animations in that the animating effect is typically incorporated in one-color of a color process, such as a 4-CP separation. However, hologravure techniques incorporate a holographic fringe pattern that gives a depth or 3D effect to the image, either in combination to the animation produced from one-color animation, or alone. Some example printing techniques are set forth in a series of currently pending patent applications including U.S. Application Publication Nos. 2008/0088126 entitled “Layered Image Display Applications and Methods,” 2008/0088931 entitled “Layered Image Display Sheet,” and 2008/0213528 entitled “Customized Printing with Depth Effect” all of which are incorporated herein by reference in their entireties.

In another embodiment of the invention, the image layer(s) comprise a bi-directional interlaced image. Bi-directional interlacing is an imaging process in which an interlaced image is interlaced in a first direction, e.g. side-to-side or left-to-right, and an interlaced image is interlaced in a second direction, e.g. top-to-bottom. The bi-directional interlaced image can then be printed. One-color animation can be incorporated into the bi-directional interlaced image to accommodate limitations in the printing process. Bi-directional interlacing can be used, for example, to create a 3D or animation illusion in a first direction, while creating other animation, color change, or a 3D effect in a second direction, depending on the viewing angle.

Optionally, one or more opaque ink layers (not shown) can be applied to the image layer(s) and the lens sheet. The opaque ink layer can comprise, for example, a white acrylic ink. The opaque ink layer can be applied multiple times in order to provide sufficient opacity. The optional opaque ink layer can be applied by any of a number of printing techniques, such as, for example, lithographic, flexographic, screen printing, gravure, digital ink jet, digital drop on demand, digital thermal printing, digital laser printing, digital xerographic printing, and combinations thereof. The medium used for the opaque ink layer can comprise, for example, acrylic inks, toners, and/or the like that can be cured by air, radiation, heat, fuser roller, or combinations thereof.

One or more optional coating layers, such as a primer layer, can be applied to the lens sheet before printing and/or to the image layer after printing. This optional coating layer can provide protection to the image layer to prevent scratching, peeling, and/or the like, or can act as an adhesion promoter for the image layer. The optional coating layers can comprise, for example, a UV coating such as a hard coating, primer, or any of a variety of coatings, and combinations thereof. The optional coating layers can be applied using standard coating techniques, such as, for example, roll coating, curtain coating, screen coating, spray coating, and combinations thereof, and/or any of a variety of printing techniques, such as, for example, lithographic, flexographic, screen printing, gravure, digital ink jet, digital drop on demand, digital thermal printing, digital laser printing, digital xerographic printing, and combinations thereof. The optional coating layers can be cured by air, radiation, heat, fuser roller, and combinations thereof.

In an alternative embodiment of illustrated in FIG. 6, assembly 600 includes image layer 152 printed on lens sheet 150 to form lens sheet assembly 108. Lens sheet assembly 108 is then inserted into a window 602 in a panel, such as, for example, front panel 604a by any suitable means, such as, for example, by securing a portion of lens sheet 150 to an inside surface of front panel 604a with one or more adhesive areas 606. Front panel 604a is sealed to back panel 604b, as described above, to sandwich card 106 and optional set of terms and conditions 160 between panels 604a and 604b.

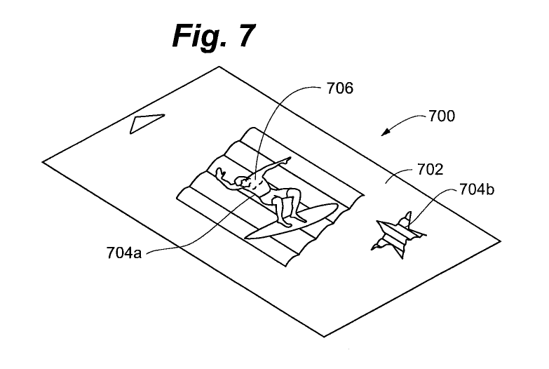

Referring to another embodiment of the invention, shown in FIG. 7, a carrier 700 having a lens sheet assembly 702 comprises one or more discrete lens arrays 704, each lens array 704 comprising a plurality of lenses, as described above. Images can be positioned below the lens array, such as lens array 704a such that images 706 viewable therethrough. Alternatively, one or more of lens array, such as 704b, or in some embodiments all of the lens arrays are image-free, as the lens array itself can provide the decorative feature, whether it be the overall shape of the array, and/or the shape of each individual lens.

In one embodiment of the invention, the carrier assembly includes a secure system for account verification, identification, and activation. The card sandwiched within the panels of the carrier can include, for example, various personalized or unique indicia (e.g., a PIN, account numbers, and/or other alphanumeric codes) that is private to the customer or account holder, and account verification indicia different from the unique indicia but both correlated with the same prepaid account. The face of the card with the unique indicia is removably attached to an interior surface of either the front panel or the rear panel of the carrier so that the unique indicia are concealed by the panel to which card is attached.

The card and/or the rear panel of the carrier can comprise activation indicia in an exposed location. Activation indicia can comprise a magnetically or optically coded strip correlated with the prepaid account associated with the unique indicia and the account verification indicia. Activation indicia on the carrier can be quickly machine readable at the cash register to activate the prepaid account.

In one embodiment of the invention, activation indicia comprises a magnetic stripe that can be hot stamped applied or laminated onto one or more panels of the carrier. In one embodiment of the invention, individual panels of the carriers are manufactured, and the activation indicia can be applied to each individual panel. In an alternative embodiment of the invention, multiple panels are printed on sheet stock, and the activation indicia is applied before and/or after converting the sheet stock to individual panels. In one particular embodiment of the invention, one or more magnetic stripes can be applied to a sheet stock pursuant to U.S. Pat. No. 6,481,994 entitled “Apparatus for Making a Magnetically Readable Card,” U.S. Pat. No. 6,964,810 entitled “Magnetically Readable Card and a Method of Making a Magnetically Readable Card,” and U.S. Pat. No. 7,300,535 entitled “Magnetically Readable Card and a Method of Making a Magnetically Readable Card,” all of which are incorporated herein in their entirety.

Carriers according to any of the above-described embodiments can optionally include a security tag, such as an RFID tag either printed or applied via a label to an interior of the carrier so that it cannot be removed without tampering with the package.

Carriers according to any of the above-described embodiments can optionally include auxiliary panels that are hingedly coupled to one or more of the front or rear panels. One or more transaction cards or other articles can be coupled to the auxiliary panel and folded within the carrier, such as the carriers described in U.S. Application Publication No. 2009/0107682, entitled “Fraud Resistant Stored Value Card and Carrier System,” incorporated herein by reference in its entirety.

The invention may be embodied in other specific forms without departing from the essential attributes thereof; therefore, the illustrated embodiments should be considered in all respects as illustrative and not restrictive.

What is claimed is:

1. A carrier assembly for packaging an article, the carrier comprising:
an article; and
a carrier, the carrier including—
a front panel comprising a lens sheet assembly including a polymeric lens sheet having a plurality of lenses on at least a portion of the first surface, and at least one image layer applied to a second, planar surface of the lens sheet, such that the at least one image layer is viewable through the lens sheet, and
a rear panel coupled to the front panel at least partially enclose the article therebetween,
wherein the carrier is tamper-evident or tamper proof, and wherein the article is not viewable through the front panel.

2. The carrier assembly of claim 1, wherein the at least one image layer is printed directly on the second surface of the lens sheet.

3. The carrier assembly of claim 1, wherein the at least one image layer is printed on a substrate, and the substrate is bonded to the second surface of the lens sheet.

4. The carrier assembly of claim 1, wherein the article comprises at least one transaction card, the transaction card comprising a credit card, a debit card, a prepaid card, a gift card, a phone card, a loyalty card, an identification card, or combinations thereof.

5. The carrier assembly of claim 4, wherein at least one of the front panel, the rear panel, and the transaction card comprises activation indicia correlated with a metered account, the activation indicia comprising a magnetic stripe, a bar code, a alphanumeric code, or a combination thereof.

6. The carrier assembly of claim 5, wherein the transaction card includes the activation indicia, and the rear panel comprises structure defining an aperture such that the activation indicia is accessible, and the transaction card is activatable without opening the carrier.

7. The carrier assembly of claim 5, wherein the rear panel comprises the activation indicia such that no access to the transaction card is required for activation of the card.

8. The carrier assembly of claim 1, wherein indicia is printed on at least one of the article, the rear panel, the front panel, a separate substrate, the indicia being selected from a group including a personal identification number, account number, or an alphanumeric code unique to the article, the indicia being concealed within the carrier.

9. The carrier assembly of claim 8, wherein a removable layer is applied over the indicia, wherein the removable layer is removed by scratching off, peeling, or opening the removable layer.

10. The carrier assembly of claim 1, wherein the plurality of lenses comprise lenticular lenses.

11. The carrier assembly of claim 1, wherein the plurality of lenses comprise fly's eye lenses.

12. The carrier assembly of claim 1, wherein the first surface of the lens sheet comprises a plurality of lenses on at least two discrete portions, and wherein at least two discrete portions of the second surface corresponding comprises an image layer, such that an image is viewable through each of the plurality of lenses.

13. A method for securely packaging a transaction card, the method comprising:
providing a carrier, the carrier comprising a front panel and a rear panel;
positioning at least one transaction card between the front panel and the rear panel;
securing the front panel to the rear panel such that the at least one transaction card is secured within the carrier; and
applying a lens sheet assembly to at least one of the front panel and the rear panel, the lens sheet assembly including a polymeric lens sheet having a plurality of lenses on at least a portion of the first surface, and at least one image layer applied to a second, planar surface of the lens sheet, such that the at least one image layer is viewable through the lens sheet.

14. The method of claim 13, wherein the at least one image layer is printed directly on the second surface of the lens sheet.

15. The method of claim 13, wherein the at least one image layer is printed on a substrate, and the substrate is bonded to the second surface of the lens sheet.

16. The method of claim 13, wherein the at least one transaction card comprises a credit card, a debit card, a prepaid card, a gift card, a phone card, a loyalty card, an identification card, or combinations thereof.

17. The method of claim 13, wherein at least one of the front panel, the rear panel, and the transaction card comprises activation indicia correlated with a metered account, the activation indicia comprising a magnetic stripe, a bar code, a alphanumeric code, or a combination thereof.

18. The method of claim 13, wherein the transaction card includes the activation indicia, and the rear panel comprises structure defining an aperture such that the activation indicia is accessible, and the method further comprises activating the transaction card without opening the carrier via reading or scanning the activation indicia through the aperture.

19. The method of claim 13, wherein the rear panel comprises the activation indicia, and the method further comprises activating the transaction card via reading or scanning the activation indicia without accessing the transaction card.

20. The method of claim 13, further comprising printing indicia on at least one of the transaction card, the rear panel, the front panel, or a separate substrate, the indicia being selected from a group including a personal identification number, account number, or an alphanumeric code unique to the transaction card, the indicia being concealed within the carrier the indicia being concealed within the carrier.
